(19) United States
(12) Patent Application Publication
(10) Pub. No.: US 2006/0231706 A1
(43) Pub. Date: Oct. 19, 2006

(54) Pole mounting base

(76) Inventor: Bruce Wyatt, Garland, TX (US)

Correspondence Address: JACKSON WALKER LLP, 901 MAIN STREET, SUITE 6000, DALLAS, TX, 75202-3797, US

(21) Appl. No.: 11/288,687

(22) Filed: Nov. 29, 2005

Related U.S. Application Data
(60) Provisional application No. 60/671,881, filed on Apr. 15, 2005.

(51) Int. Cl. G09F 7/18

(52) U.S. Cl. 248/218.4; 248/230.5; 248/231.61

(57) ABSTRACT

A pole mounting base having at least two members configured to be securely juxtaposed about a vertical member and secured to a mount to secure the pole in a vertical position.

### FIELD OF THE INVENTION

The present invention is generally related to a support for securing a member in a vertical orientation, and more particularly to a mounting base for securing a pole to a mount, including flag poles, light standards and the like.

### BACKGROUND OF THE INVENTION

There are numerous known ways of securely supporting vertical members, including flag poles, light posts, signs and so forth. Some known solutions include the member having a flanged foot with openings therethrough adapted to receive vertically extending members, such as bolts, integrated into a base or concrete. In some cases, the pole is simply inserted into a hole and backfilled with cement or the like.

Mounting bases are also known for securing a vertical member to the earth, although some of these designs are time consuming during insulation, expensive, and/or having limited application. The bases are welded on using circumferences welds causing a heat affected zone at the most critical portion of the pole. By eliminating the circumference weld, the full strength of the metal remains.

There is desired an improved pole mounting base that can be quickly installed with no special equipment, suitable for numerous applications, easy to manufacture, relatively inexpensive, and will not reduce the pole strength.

### SUMMARY OF INVENTION

The present invention achieves technical advantages as a mounting base having at least two members configured to be securely juxtaposed about a vertical member, and to a base to secure the pole in a vertical position.

In one preferred embodiment of the present invention, a pair of members each have a first flanged portion configured to be securely coupled to the other, and each also comprising a second flanged portion adapted to be secured to a support base. Through each of the flanged portions is comprised at least one opening for receiving hardware to secure the members to each other, and to the support base. These openings may be elongated to provide for adjustments during alignment of the members with respect to each other, and to orient the pole in the vertical direction. When secured together, the members form a geometric shape to provide an aesthetically pleasing appearance.

### BRIEF DESCRIPTION OF THE DRAWINGS

FIG. 1 is an exploded perspective view of a first embodiment of the present invention adapted to be secured about a pole;

FIG. 2 is a top view of the base shown in FIG. 1;

FIG. 3 is a side view of one base member;

FIG. 4 is a top view of the base of FIG. 1 with the two members secured together to define a round shape;

FIG. 5 is an alternative preferred embodiment of the present invention whereby the integrated members define a square geometric shape;

FIG. 6 is a top view of another preferred embodiment of the present invention wherein the integrated members define a hexagon geometric shape; and

FIG. 7 is another preferred embodiment of the present invention wherein the integrated members define an octagon geometric shape.

### DETAILED DESCRIPTION OF THE PRESENT INVENTION

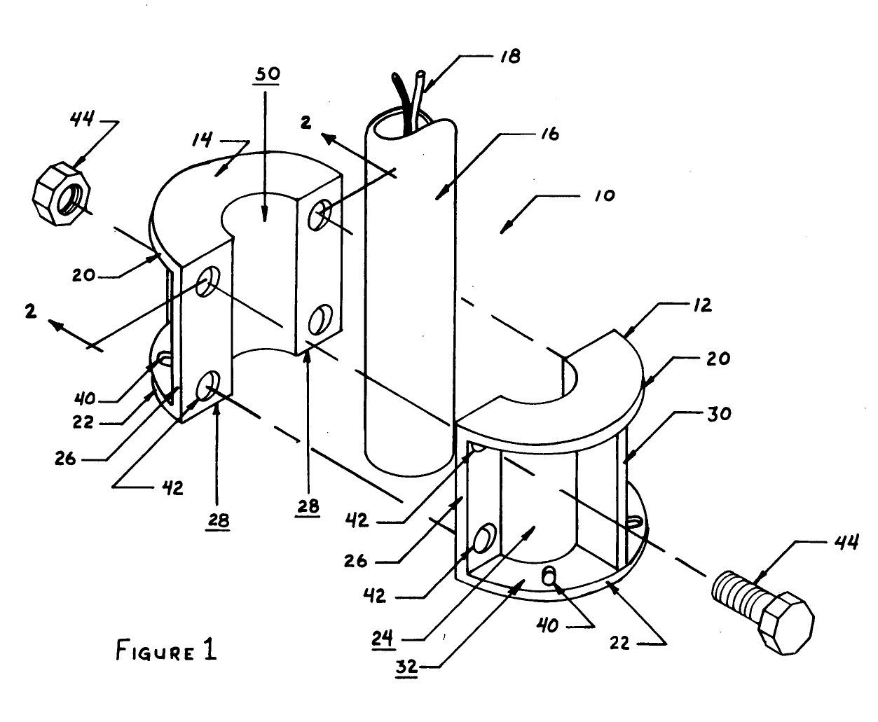

Referring now to FIG. 1, there is generally shown at 10 a first embodiment of the present invention seen to comprise a mounting base 10. Base 10 comprises a plurality of members, seen to comprise of two identical members 12 and 14 configured to be securely juxtaposed about a vertical member 16, such as a pole, having electrical conductors 18 extending therethrough. In this embodiment, each member 12 and 14 has an upper flanged portion 20 and a lower flanged portion 22 that are generally parallel to each other, and separated by a vertical portion 24. Each member 12 and 14 further includes a pair of vertically extending flanged portions 26 defining a coplanar face portion 28, as shown. Extending between the upper flanged portion 20 and lower flanged portion 22 is a vertical rib 30 secured to both the vertical portion 24 and the opposing inside surfaces 32 of flanged members 20 and 22.

Each of members 12 and 14 are preferably comprised of a ridged material, such as a metal, plastic or other suitable material, of sufficient thickness and strength so as to support the vertically extending member 16 when each member is secured thereabout, and when secured to a mount, as will be described in more detail shortly.

Still referring to FIG. 1, the lower flanged portion 22 is seen to include a plurality of openings 40 extending therethrough, and each preferably having an elongated shape, as shown, so as to allow adjustments of the respective member 12 and 14 with respect to a mount during installation. Each of the openings 40 extends in generally a radial direction. Each of the vertical flanged portions 26 also include a plurality of openings 42 extending therethrough, and having an elongated shape as shown. Openings 42 are adapted to receive hardware 44, such as a bolt and nut, or other suitable fastening hardware.

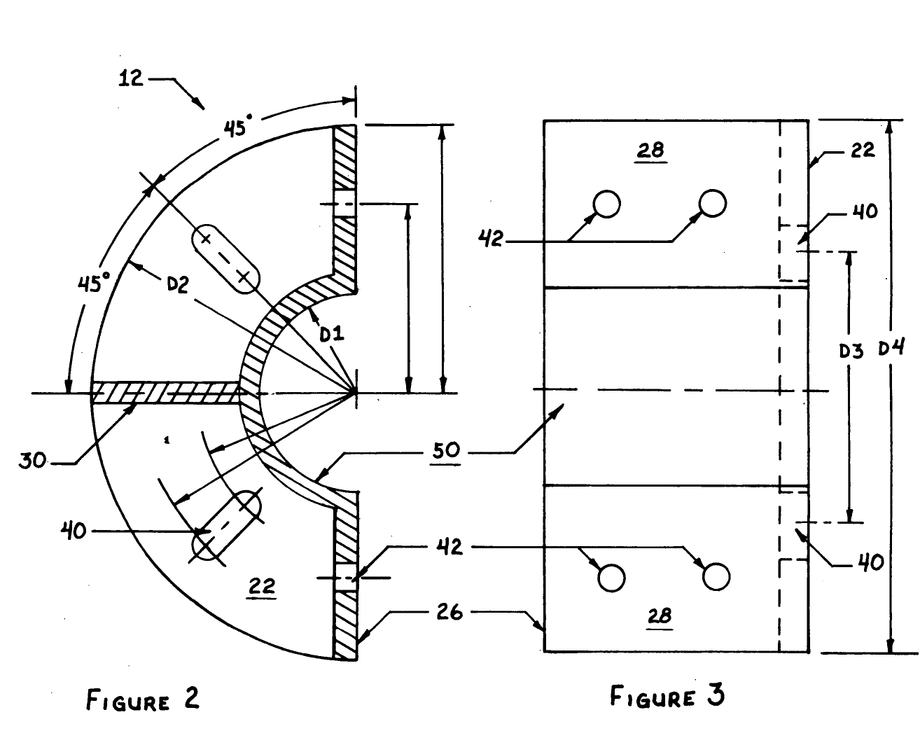

Referring now to FIG. 2, there is shown a sectional top view of member 12 taken along lines 2-2 in FIG. 1. As shown, member 12 has a central arcuate surface 50 having a radius of curvature generally conforming to the outer radius of curvature of the vertical member 16 to be secured therein. This inner radius of curvature is shown as dimension D1. The radius of curvature for the outer edge of each flanged portion 20 and 22 is depicted by dimension D2. Each of the openings 40 are seen to be elongated in the radial direction, and are centered between the inner portion 50 and the outer edge of the flange portion 22. Each of the openings 42 disposed in the vertical flanged portion 26 are also seen to be centered between the inner surface 50 and the outer edge of flanged 22.

FIG. 3 depicts a side view of member 12, and depicting the spacing between openings 42 as having a dimension D3.

By way of illustration, but without limitation thereto, member 12 and 14 may have the following dimensions. Dimension D4 may be 10¼ inches, whereby dimension D1 may be 2 inches. Dimension D2 may be 5⅛ inches, and dimension D3 may be 3.42 inches. The thickness of member 30 maybe ½ inches, the thickness of the vertical portion 24 may be ¼ inches, and the thickness of vertical flanged portion 26 may be ½ inches. Openings 40 are disposed at about 45 degrees with respect to the proximate face portion 28, and thus are arcuately separated from each other by about 90 degrees.

The members 12 and 14 may be comprised of any number of materials including steel, aluminum, plastic, or other suitable rigid materials. The height and thickness of side flanged portions 28 is a function of the member 16 to be supported. The taller and heaver the member 16, the longer the necessary flanged portion 28 and vertical portion 50 to provide suitable rigidity about the member 16 to safely and adequately maintain it in the vertical position. In the preferred embodiment being discussed by way of example, this dimension may be about 12 inches.

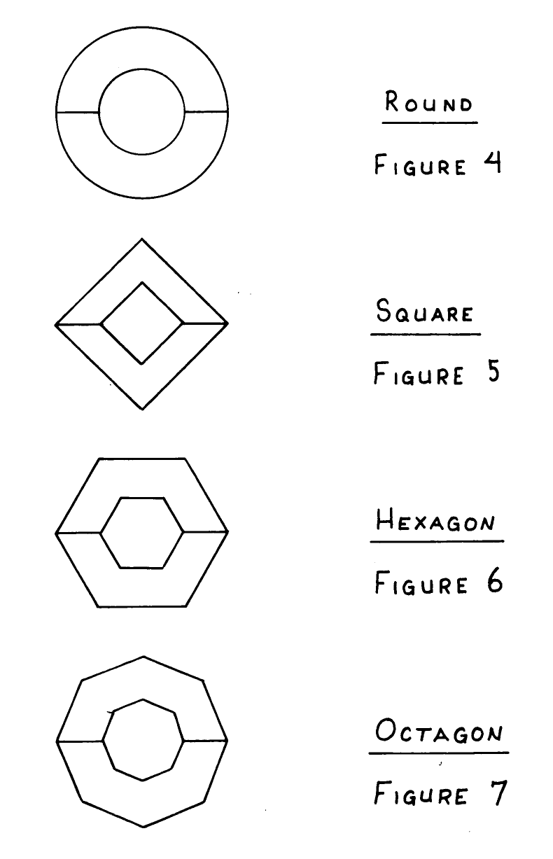

FIGS. 4-7 show additional embodiments of the present invention, wherein each member is configured to form a geometric shape when secured about the pole. FIG. 4 depicts a round configuration realized according to the first embodiment. FIG. 5 depicts a square configuration having members 52 and 54. FIG. 6 depicts a hexagon configuration having members 60 and 62, and FIG. 7 depicts an octagon configuration having members 70 and 72. Other geometric configurations are possible and limitation to these embodiments is not to be inferred.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A base, comprising;
a first member and a second member configured to be securely juxtaposed about an elongated vertical member, the first and second members configured to be secured together in a direction transverse to the vertical member, and further configured to be secured to a mount in a direction generally parallel to the vertical member.

2. The base as specified in claim 1 wherein the first and second members each have a respective first flanged portion configured to abut one another when juxtaposed about the vertical member.

3. The base as specified in claim 2 wherein the first and second members each have a respective second flanged portion extending generally transverse to the respective first flanged portion.

4. The base as specified in claim 3 wherein each of the first flanged portions are coplanar.

5. The base as specified in claim 4 wherein each of the second flanged portions are coplanar.

6. The base as specified in claim 3 wherein each of the second flanged portions have a generally arcuate shape.

7. The base as specified in claim 5 wherein each of the second flanged portions have a generally arcuate shape.

8. The base as specified in claim 6 wherein the second flanged portions each have a curved outer edge.

9. The base as specified in claim 3 wherein the first and second flanged portions define a geometric shape when juxtaposed about the vertical member.

10. The base as specified in claim 9 wherein the geometric shape is selected from the group comprising: round, square, hexagon, and octagon.

11. The base as specified in claim 3 wherein the first and second flanged portions each have an opening defined therethrough.

12. The base as specified in claim 11 wherein each of the openings are elongated.

13. The base as specified in claim 11 wherein the second flanged portions having an opening therethrough.

14. The base as specified in claim 13 wherein each of the first and second openings are elongated.

15. The base as specified in claim 3 wherein the first and second members each have a rib configured to reinforce the respective member.

16. The base as specified in claim 15 wherein the rib is generally parallel to the vertical member when secured about the vertical member.

17. The base as specified in claim 1 further comprising the elongated vertical member, wherein the first and second members are securely juxtaposed about the vertical member.

18. The base as specified in claim 17 wherein the vertical member comprises a pole.

19. The base as specified in claim 18 wherein the pole comprises a flag pole.

20. The base as specified in claim 17 wherein the vertical member comprises at least one electrical conductor extending therethrough.
